(19) United States
(12) Patent Application Publication
(10) Pub. No.: US 2022/0215448 A1
(43) Pub. Date: Jul. 7, 2022

(54) SYSTEM AND METHOD FOR VALUATION OF AN ELECTRONIC DEVICE

(71) Applicant: PrologMobile, Inc., Louisville, CO (US)

(72) Inventors: Seth David Heine, Louisville, CO (US); Jonathan Richard Newman, Saint Augustine, FL (US); Daniel Thomas Ricci, Peyton, CO (US); Zachary Alan Vorwaller, Peyton, CO (US)

(73) Assignee: PrologMobile, Inc.

(21) Appl. No.: 17/140,262

(22) Filed: Jan. 4, 2021

(51) Int. Cl. G06Q 30/06; G06Q 10/00; G06Q 30/02

(52) U.S. Cl. CPC G06Q 30/0611; G06Q 20/18; G06Q 30/0278; G06Q 10/30

(57) ABSTRACT

A system and method for valuation of an electronic device is disclosed. A device information extraction subsystem derives a unique device identification number associated with the device. A device information extraction subsystem obtains characteristic information associated with the device. A device examination subsystem determines one or more network bands and one or more carriers responsible for sim-lock status of the device, identifies a compatibility of the one or more carriers with the device, and aligns the device with one or more supportive carriers to target the one or more supportive carriers. A device diagnosis subsystem diagnoses at least one fault factor associated with the device. A device valuation subsystem estimates a pricing for refurbishing the device using a price estimation technique, and determines a valuation of the device for reusage via a plurality of device reusage paths.

### BACKGROUND

Embodiments of the present disclosure relate to a system for managing the life cycle of a product and more particularly to a system and a method for valuation of an electronic device.

Consumer electronic devices, such as mobile phones, laptop computers, notebooks, tablets, and the like are ubiquitous. Such consumer electronic devices are tremendously utilized all over the world and the number of these devices available are more than there are people on the planet. Part of the reason for the rapid growth in the number of the consumer electronic devices such as mobile phones is the rapid pace at which these devices are evolving with one or more latest features and the increased demand of such devices for handling one or more applications. As a result of the rapid pace of development, a relatively high percentage of mobile phones are replaced every year as consumers continually upgrade their electronic devices to obtain the latest features, a better operating plan, or as a replacement for a damaged device. Generally, for the replacement of mobile phones, many electronic device retailers and cell carrier stores offer mobile phone trade-in or buyback programs. Also, before replacement, value analysis of the electronic devices is done by the electronic device retailers, or collection entities so that the electronic devices do not end up in landfills or are improperly disassembled or disposed of in one or more areas.

Conventionally, systems available for the valuation of the electronic devices include collecting several electronic devices and analyzing each of the devices individually; but with little to no data collected for the device's IMEI status, nor the device's hardware integrity, nor assessment of the cosmetics in a non-subjective manner. Such a conventional system focuses mainly on subjective and cursory assessments regarding one or more hardware failures of the electronic devices such as one or more broken parts, damages, cosmetic problems, and the like. Moreover, such a conventional system is unable to determine one or more measures or costs involved for repairing or reusing the electronic devices and as a result, affects the operational and financial status of the electronic devices. Furthermore, such a conventional system requires the involvement of middlemen for value analysis of the electronic devices and does not provide transparency in the reselling process of the electronic devices to the one or more consumers.

Hence, there is a need for an improved system and a method for valuation of an electronic device in order to address the aforementioned issues.

### BRIEF DESCRIPTION

In accordance with an embodiment of the present disclosure, a system for valuation of an electronic device comprising a device information extraction subsystem hosted on a server, wherein the device information extraction subsystem is configured to derive a unique device identification number associated with the electronic device received in a device receiving arrangement, and obtain characteristic information associated with the electronic device by querying a device information storage repository using the unique device identification number derived, a device examination subsystem operatively coupled to the device information extraction subsystem, wherein the device examination subsystem is configured to determine one or more network bands and one or more carriers responsible for sim-lock status of the electronic device based on the unique device identification number, identify a compatibility of the one or more carriers with the electronic device upon determination of the one or more network bands and the one or more carriers, and align the electronic device with one or more supportive carriers to target the one or more supportive carriers for returning the electronic device via one or more carrier-based returning rewards programs upon identification of the compatibility a device diagnosis subsystem operatively coupled to the device examination subsystem, wherein the device diagnosis subsystem is configured to diagnose and test for at least one fault factor associated with the electronic device, alignment of the electronic device with the one or more supportive carriers and a physical and/or electronic inspection of the electronic device, and a device valuation subsystem operatively coupled to the device diagnosis subsystem, wherein the device valuation subsystem is configured to, estimate a price for refurbishing the electronic device using a price estimation technique based on the test for at least one fault factor diagnosed for the electronic device, and determine a valuation of the electronic device for reusage via a plurality of device reusage paths based on the price for refurbishing of the electronic device estimated. The system may also include where the unique device identification number comprises an international mobile equipment identity (IMEI) number. wherein the system analyzes the device's IMEI and determines the device's radio frequency, topology attributes, and compatibility for each carrier network. The system may also include where the characteristic information comprises at least one of a manufacturing company of the device, a manufacturing company location of the device, a model number of the device, a model name of the device, a specification of the device, a location of last active state of the device, a last network connection associated with the device, or a combination thereof. The system may also include where the device information storage repository is created by pulling and integrating one or more details associated with the device from one or more external sources, wherein the device information storage repository stores the characteristic information of the device. The system may also include where the one or more supportive carriers comprises one or more additional carriers allowing network connectivity of the device without sim-locking of the device. The system may also include where the one or more returning rewards comprises one or more bring your own device associated incentives. The system may also include where the tests for at least one fault factor comprises at least one of a tampered electronic device, an inactivity or lack of device payment, an unfulfilled service contract, a status of a subscriber identity module (SIM) of the device, a battery issue, a screen damage, one or more cosmetic issues, functionality of all components including buttons, cameras, chipsets, or a combination thereof. The system may also include where the physical inspection of the device is performed by using one or more device inspection image acquisition devices, or one or more device inspection optical sensors deployed at the device receiving arrangement. The system may also include where the pricing for refurbishing the device comprises a buying price applicable for a buyer, and/or a take-to-market-price applicable for a seller of the device. The system may also include where the price estimation technique comprises at least one of a linear regression technique, a gradient boosting technique, a ransom forest technique, use of marketplace prices, or a combination thereof. The system may also include where the plurality of device reusage paths comprises at least one of marketplaces selling of the devices, a repair coverage of the device, a carrier activation incentivizing scheme, or a combination thereof. The system may also include a device status visualization subsystem operatively coupled to the device information extraction subsystem, the device examination subsystem, and the device diagnosis subsystem, wherein the device status visualization subsystem is configured to represent at least one of a unique device identification number, a compatibility status, and at least one fault factor of the device in one or more visualization forms. The system may also include where the one or more visualization forms comprises at least one of a bar graph, a pie chart, a scatter plot, a histogram, a tabular representation, a representation of a mobile device with working and faulty parts communicated through the use of contrasting colors to indicate functionality, or a combination thereof. The system may also include a device refurbishing tracking subsystem operatively coupled to the device valuation subsystem, wherein the device refurbishing tracking subsystem is configured to track a complete refurbishment process of the device in real-time, including serialized parts tracking on a per device/IMEI/motherboard serial number basis. The system may also include a report generation subsystem configured to generate a plurality of reports to provide in depth information associated with proprietary analytics of the device in real time. The system may also include where the proprietary analytics comprises at least one of the unique device identification number, derived data of the device, a hardware status of the device, the at least one fault factor, a functionality of the device, or a combination thereof.

In accordance with an embodiment of the present disclosure, a method that includes deriving, by a device information extraction subsystem, a unique device identification number associated with an electronic device received in a device receiving arrangement, obtaining, by the device information extraction subsystem, characteristic information associated with the device by querying a device information storage repository using the unique device identification number derived, determining, by a device examination subsystem, one or more network bands and one or more carriers responsible for sim-lock status of the device based on the unique device identification number, identifying, by the device examination subsystem, a compatibility of the one or more carriers with the device upon determination of the one or more network bands and the one or more carriers, aligning, by the device examination subsystem, the device with one or more supportive carriers to target the one or more supportive carriers for returning the device via one or more returning rewards upon identification of a compatibility, diagnosing, by a device diagnosis subsystem, at least one fault factor associated with the device based on the compatibility of the device, alignment of the device with the one or more supportive carriers, and a physical inspection of the device, estimating, by a device valuation subsystem, a price for refurbishing the device using a price estimation technique based on the at least one fault factor diagnosed for the device, and determining, by the device valuation subsystem, a valuation of the device for reusage via a plurality of device reusage paths based on the price for refurbishing of the device estimated. The method may also include representing, by a device status visualization subsystem operatively coupled to the device information extraction subsystem, the device examination subsystem, and the device diagnosis subsystem, at least one of the unique device identification number, a compatibility status, and the at least one fault factor of the device in one or more visualization forms. The method may also include tracking, by a device refurbishing tracking subsystem operatively coupled to the device valuation subsystem, a complete refurbishment process of the device in real-time. The method may also include analyzing, by the device examination subsystem, the device's international mobile equipment identity, radio frequency, topology attributes, and compatibility for each carrier network.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for valuation of an electronic device in accordance with an embodiment of the present disclosure;

FIG. 2 illustrates a schematic representation of an embodiment of a system for valuation of an electronic device of FIG. 1 in accordance with an embodiment of the present disclosure;

FIG. 3 illustrates a schematic representation of an exemplary embodiment of a system for valuation of an electronic device of FIG. 1 in accordance with an embodiment of the present disclosure;

FIG. 4 is a block diagram of a computer or a server in accordance with an embodiment of the present disclosure; and

FIGS. 5(a) and 5(b) represent continued steps of a flow chart illustrating the steps involved in a method for valuation of an electronic device in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for valuation of an electronic device. The system includes a device information extraction subsystem hosted on a server. The device information extraction subsystem is configured to derive a unique device identification number associated with the electronic device received in a device receiving arrangement. The device information extraction subsystem is also configured to obtain characteristic information associated with the electronic device by querying a device information storage repository using the unique device identification number derived. The system also includes a device examination subsystem operatively coupled to the device information extraction subsystem. The device examination subsystem is configured to determine one or more network bands and one or more carriers responsible for sim-lock status of the electronic device based on the unique device identification number. The device examination subsystem is also configured to identify a compatibility of the one or more carriers with the electronic device upon determination of the one or more network bands and the one or more carriers. The device examination subsystem is also configured to align the electronic device with one or more supportive carriers to target the one or more supportive carriers for returning the electronic device to reuse via one or more carriers, and potentially their “BYOD” rewards systems upon identification of the compatibility. The system also includes a device diagnosis subsystem operatively coupled to the device examination subsystem. The device diagnosis subsystem is configured to diagnose at least one fault factor associated with the electronic device, alignment of the electronic device with the one or more supportive carriers and a physical inspection of the electronic device to determine Cosmetic Grade, or to couple the device to subsystems to determine the Cosmetic Grade of the device. The system also includes a device valuation subsystem operatively coupled to the device diagnosis subsystem. The device valuation subsystem is configured to estimate a price for refurbishing the electronic device using a price estimation technique based on at least one fault factor diagnosed for the electronic device. The device valuation subsystem is also configured to determine a valuation of the electronic device for reuse via a plurality of device reuse paths based on the pricing for refurbishing of the electronic device estimated.

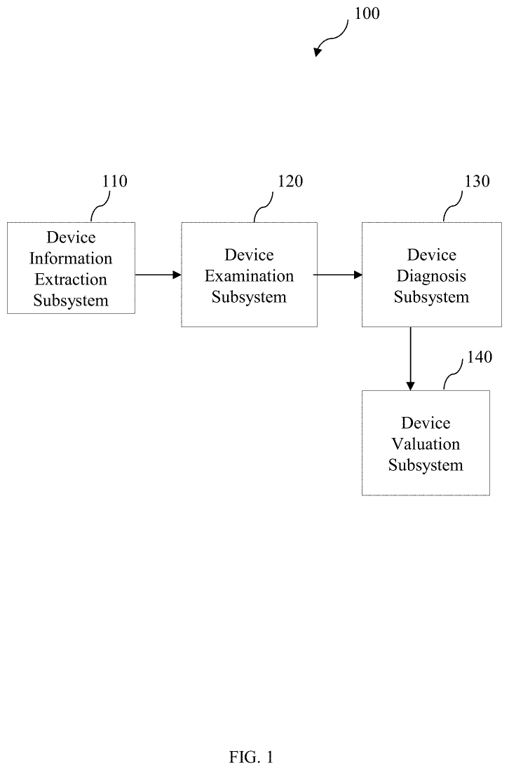

FIG. 1 is a block diagram of a system 100 for valuation of an electronic device in accordance with an embodiment of the present disclosure. The system 100 includes a device information extraction subsystem 110 hosted on a server. The device information extraction subsystem 110 is configured to derive a unique device identification number associated with the electronic device received in a device receiving arrangement. As used herein, the term ‘electronic device’ is defined as a hand-held and/or a mobile device which is used for communication purposes. In one embodiment, the unique device identification number may include an international mobile equipment identity number (IMEI) number. In a specific embodiment, the device receiving arrangement may include a standalone physical machine for collecting one or more electronic devices. In such embodiment, the standalone physical machine may include an opening adapted to receive the electronic device deposited by a user.

The device information extraction subsystem 110 is also configured to obtain characteristic information associated with the electronic device by querying a device information storage repository using the unique device identification number derived. The device information storage repository is created by pulling and integrating one or more details associated with the electronic device from one or more external sources, wherein the device information storage repository stores the characteristic information of the electronic device. In one embodiment, the characteristic information may include at least one of a manufacturing company of the electronic device, a manufacturing company location of the electronic device, a model number of the electronic device, a model name of the electronic device, a specification of the electronic device, a location or Carrier of last active state of the electronic device, a last network connection associated with the electronic device or a combination thereof.

The system 100 also includes a device examination subsystem 120 operatively coupled to the device information extraction subsystem 110. The device examination subsystem 120 is configured to determine one or more network bands and one or more carriers responsible for sim-lock status of the electronic device based on the unique device identification number. The unique device identification number such as the IMEI or Serial Number helps in determining the presence of one or more network bands, and/or potential carriers that might have sim-locked the electronic device. In one embodiment, the one or more carriers may include one or more mobile operators offering wireless connection services, or “BYOD” rewards or incentives to consumers to activate the device on their networks.

The device examination subsystem 120 is also configured to identify a compatibility based on specific radio transceiver capabilities (i.e., presence of “bands”) of the one or more carriers with the electronic device upon determination of the one or more network bands. The compatibility of the one or more carriers are identified by sequencing of data through filtration of band data, and query of the one or more carriers.

The device examination subsystem 120 is also configured to align the electronic device with one or more supportive carriers to target the one or more supportive carriers for returning the electronic device to reuse via one or more carrier “BYOD” (Bring Your Own Device) reward or incentive programs upon identification of the compatibility. In some embodiments, the one or more compatible carriers may offer activation incentives such as bring your own device (BYOD) associated incentives. The BYOD incentives create value for one or more device owners, end consumers, the one or more carriers and others.

The system 100 also includes a device diagnosis subsystem 130 operatively coupled to the device examination subsystem 120. The device diagnosis subsystem 130 is configured to diagnose at least one fault factor associated with the electronic device, alignment of the electronic device with the one or more supportive carriers and a physical or mechanical inspection of the electronic device to assess hardware functionality and Cosmetic Grade. Diagnostics of the device's hardware state may be performed by electronic and/or physical examination of the device. In one embodiment, the at least one fault factor may include at least one of a tampered electronic device, an inactivity or lack of device payment, or unfulfilled service contract, a status of subscriber identity module (SIM) of the electronic device, a battery issue of the electronic device, a screen damage of the electronic device, one or more cosmetic issues of the electronic device, functionality of all components including buttons, cameras, chipsets (memory, processors, wi-fi, LIDAR), light/proximity sensors, gyroscopes etc. or a combination thereof. The physical inspection of the electronic device cosmetics is performed by human inspection or by using one or more device inspection image acquisition devices, or one or more device inspection optical sensors deployed at the device receiving arrangement. In one embodiment, the one or more device inspection image acquisition devices may include one or more cameras deployed at one or more predetermined points of the device receiving arrangement.

The system 100 also includes a device valuation subsystem 140 operatively coupled to the device diagnosis subsystem 130. The device valuation subsystem 140 is configured to estimate a price for refurbishing the electronic device using a price estimation technique based on the at least one fault factor diagnosed for the electronic device. The price estimation technique not only helps the consumers to decide the right phone to purchase but also helps the one or more device owners to decide what should be an appropriate pricing for selling the electronic device with one or more predetermined features or defects present. In one embodiment, the price for refurbishing the electronic device may include, but not be limited to, a buying price applicable for a buyer, and an estimated value for the repaired device based upon take to market estimates for a seller of the electronic device. In such embodiments, the price estimation technique may include at least one of a linear regression technique, a gradient boosting technique, a random forest technique, market-based pricing data, other techniques, or a combination thereof. According to some embodiments, as devices are tracked through these repairs, their hardware status/serialized parts data sets within subsystem 160 are updated, giving the system 100 the ability to track these data points over multiple lifecycles on a per device basis, enabling life cycle reporting capabilities. The tracking of the refurbishment process helps in assuring device quality and longevity and supports multiple productive life cycles.

The device valuation subsystem 140 is also configured to determine a valuation of the electronic device for reusage via a plurality of device reusage paths based on the pricing for repairing or refurbishing of the electronic device estimated. In one embodiment, the plurality of device reusage paths may include multiple marketplace valuation assessments, at least one of an insurance sale for the electronic device, a warranty presentation of the electronic device, a repair coverage of the electronic device, a carrier activation incentivizing scheme, or a combination thereof.

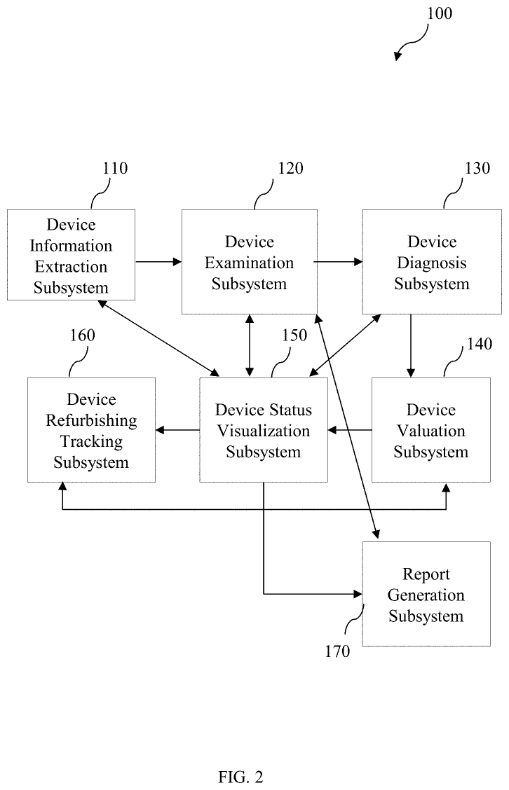

FIG. 2 illustrates a schematic representation of an embodiment of a system 100 for valuation of an electronic device of FIG. 0.1 in accordance with an embodiment of the present disclosure. As already described in aforementioned FIG. 1, the system 100 includes a device information extraction subsystem 110, a device examination subsystem 120, a device diagnosis subsystem 130, and a device valuation subsystem 140. In addition, the system 100 also includes a device status visualization subsystem 150 operatively coupled to the device information extraction subsystem 110, the device examination subsystem 120 and the device diagnosis subsystem 130. The device status visualization subsystem 150 is configured to represent the unique device identification number, a compatibility status, and at least one fault factor of the electronic device in one or more visualization forms. In one embodiment, the one or more visualization forms may include at least one of a bar graph, a pie chart, a scatter plot, a histogram, a tabular representation or a combination thereof. In another embodiment, device hardware faults may be visually represented through the likeness of the device with contrasting colors such as green or red features to communicate the failure (in red), or working (in green) for example. The system 100 further includes a device refurbishing tracking subsystem 160 operatively coupled to the device valuation subsystem 140. The device refurbishing tracking subsystem 160 is configured to track a complete refurbishment process of the electronic device in real-time. As devices are tracked through these repairs, their hardware status/serialized parts data sets within subsystem 160 are updated, giving the system the ability to track these data points over multiple lifecycles on a per device basis, enabling life cycle reporting capabilities. The system 100 further includes a report generation subsystem 170 configured to generate a plurality of reports to provide in depth information associated with proprietary analytics of the electronic device in real time. In one embodiment, the proprietary analytics may include at least one of the unique device identification number derived data of the electronic device, a hardware status of the electronic device, indication of hardware faults or functionality, cosmetic information, repair data, warranty data, BYOD Reward data, repair lifecycle data, device insurance data, assessment of functionality of the electronic device or a combination thereof.

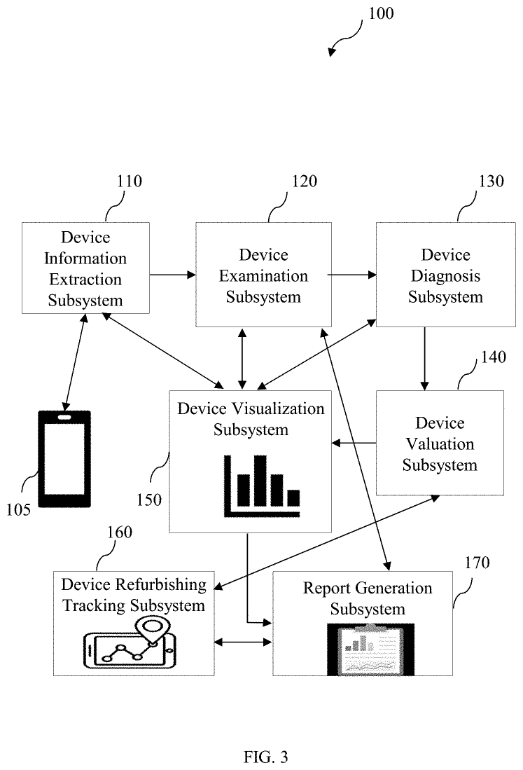

FIG. 3 illustrates a schematic representation of an exemplary embodiment of a system for valuation of an electronic device of FIG. 1 in accordance with an embodiment of the present disclosure. Considering an example, where the system 100 is utilized by an electronic device seller who wants to sell a used electronic device such as a mobile phone 105 to a customer. In such a scenario, before selling the electronic device, value analysis of the electronic device is essential in order to get a fair market value of the mobile phone. For valuation of the mobile phone, the system 100 includes a device information extraction subsystem 110 to derive a unique device identification number associated with the electronic device received in a device receiving arrangement. For example, the unique device identification number may include an international mobile equipment identity number (IMEI) number. In the example used herein, the device receiving arrangement may include a standalone vending machine in which the mobile phone is deposited for value analysis. The system 100 may be installed as an application on the device receiving arrangement. A display interface of the device receiving arrangement displays an analysis result of the electronic device performed by the system 100.

Once the unique device identification number of the electronic device is derived, the device information extraction subsystem 110 also obtains characteristic information associated with the electronic device. For example, the characteristic information may include at least one of a manufacturing company of the electronic device, a manufacturing company location of the electronic device, a model number of the electronic device, a model name of the electronic device, a specification of the electronic device, a location of last active state of the electronic device, a last network connection associated with the electronic device or a combination thereof. Let us assume that the manufacturing company of the mobile phone is ‘X’, the model number is ‘ABC-01’, the model name is ‘Y’. Similarly, the last network connection associated with the mobile phone is ‘Z telecom’. Such characteristic information associated with the mobile phone helps in detection and presentation of IMEI lock data, enabling more accurate device valuation and more efficient routing of the devices into repair and reuse. Also, the characteristic information provides an ability to organize devices based on IMEI status and hardware fault detection into homogeneous layers of like devices, sorted by cost of resolution or cost of repair, which de-risks devices from the current grab bag or mixed bag format in use today.

Again, a device examination subsystem 120 determines one or more network bands and one or more carriers responsible for sim-lock status of the electronic device based on the unique device identification number. The unique device identification number such as the IMEI or TAC data helps in determining the one or more network bands, potential carriers that might have sim-locked the electronic device. Upon determination of the one or more network bands, the device examination subsystem 120 also identifies a compatibility of the one or more carriers with the electronic device.

Identification of the compatibility also enables the device examination subsystem 120 to align the electronic device with one or more supportive carriers to target the one or more supportive carriers for returning the electronic device via one or more returning rewards. In the example used herein, the one or more supportive carriers may include one or more new carriers allowing network connectivity of the electronic device without sim-locking of the electronic device. Ability to align the electronic device with other carrier networks helps in identifying support for the electronic device with the or more carriers, rather than rejecting it due to lack of radios required for functionality. The device's values and flows shift away from “locking carriers” to carriers with no locks on the devices. Again, the one or more returning rewards may include one or more bring your own device (BYOD) associated incentives. The BYOD incentives create value for one or more device owners, end consumers, the one or more carriers and others.

Further, a device diagnosis subsystem 130 engages the device to test for at least one fault factor associated with the electronic device based on the interrogation of the electronic device, and an electronic, a physical inspection, or both of the electronic device. For example, the at least one fault factor may include at least one of a tampered electronic device, a battery issue of the electronic device, a screen damage of the electronic device, one or more cosmetic issues of the electronic device, functionality of all components including buttons, memory or processing chips, cameras, LIDAR, microphones, speakers, proximity sensors, gyroscopes, vibrator etc., or a combination thereof. In addition, the physical cosmetics inspection of the electronic device is performed manually, or by using one or more device inspection image acquisition devices, or one or more device inspection optical sensors deployed at the device receiving arrangement. In the example used herein, the one or more device inspection image acquisition devices may include one or more cameras deployed at one or more predetermined points of the device receiving arrangement.

Once the at least one fault factor is diagnosed, a device valuation subsystem 140, estimates a pricing for repairing and/or refurbishing the electronic device using a price estimation technique. The price estimation technique not only helps the consumers to decide the right phone to purchase but also helps the one or more device owners to decide what should be an appropriate pricing for selling the electronic device with one or more predetermined features or faults offered. According to some embodiments, the pricing also includes repair prices based upon parts/labor/shipping, parts and labor, or parts alone. For example, here the price for refurbishing the electronic device may include, but not be limited to, a buying price applicable for a buyer, the cost of repairs, parts, labor and shipping of the devices to actuate the repair, and a take to market price applicable for a seller of the electronic device. Also, the device valuation subsystem 140 determines a valuation of the electronic device for reusage via a plurality of device reusage paths based on the price and value created for refurbishing the electronic device estimated. In the example used herein, the plurality of device reusage paths may include multiple marketplaces, a repair warranty coverage of the electronic device, insurance coverage of the electronic device, a carrier activation incentivizing scheme, or a combination thereof.

Moreover, a device status visualization subsystem 150 represents the unique device identification number, an IMEI compatibility status check, the use of 130 to test for at least one fault factor of the electronic device conveyed in one or more visualization forms in real-time. For example, the one or more visualization forms may include at least one of a bar graph, a pie chart, a scatter plot, a histogram, a tabular representation or a combination thereof. In another embodiment, device hardware faults may be visually represented through the likeness of the device with contrasting colors such as green or red features to communicate the failure (in red), or working (in green) for example. Furthermore, a device refurbishing tracking subsystem 160 tracks a complete refurbishment process of the electronic device in real-time. As devices are tracked through these repairs, their hardware status/serialized parts data sets within subsystem 160 are updated, giving the system the ability to track these data points over multiple lifecycles on a per device basis, enabling life cycle reporting capabilities. The tracking of the refurbishment process helps in assuring device quality and longevity and supports multiple productive life cycles. In addition, the system 100 further includes a report generation subsystem 170 which generates a plurality of reports to provide in depth information associated with proprietary analytics of the electronic device in real time. For example, the proprietary analytics may include at least one of the unique device identification number derived data of the electronic device, a hardware status of the electronic device, use of 130 to test for at least one fault factor, a functionality of the electronic device or a combination thereof. Meaningful and accurate reports help in documenting an organization's positive impact on the environment. Thus, the system 100 enables better decision-making regarding the valuation and re-use path for each specific electronic device analyzed with precision and accuracy and mitigates the risk factors associated with reuse of the electronic devices.

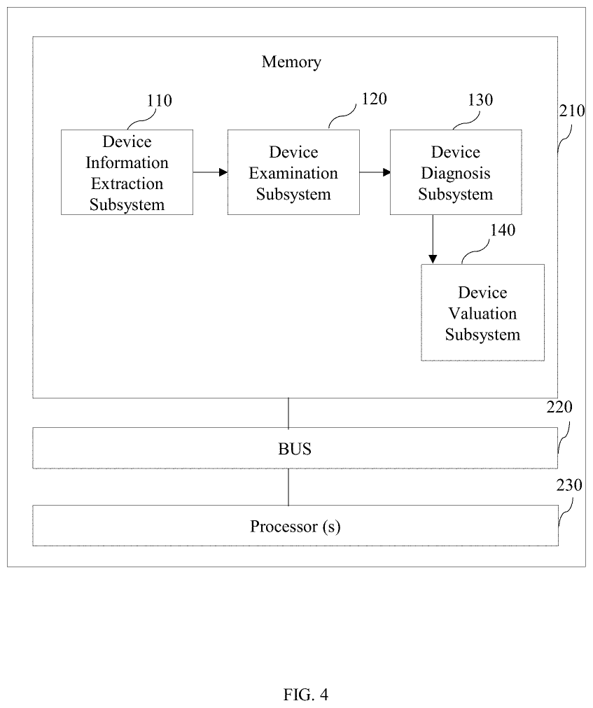

FIG. 4 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 is substantially similar to a system 100 of FIG. 1. The memory 210 has following subsystem: a device information extraction subsystem 110, a device examination subsystem 120, a device diagnosis subsystem 130, and a device valuation subsystem 140.

The device information extraction subsystem 110 is configured to derive a unique device identification number associated with the electronic device received in a device receiving arrangement. The device information extraction subsystem 110 is also configured to obtain characteristic information associated with the electronic device by querying a device information storage repository using the unique device identification number derived. The device examination subsystem 120 is configured to determine one or more network bands and one or more carriers responsible for sim-lock status of the electronic device based on the unique device identification number. The device examination subsystem 120 is also configured to identify a compatibility of the one or more carriers with the electronic device upon determination of the one or more network bands and the one or more carriers. The device examination subsystem 120 is also configured to align the electronic device with one or more supportive carriers to target the one or more supportive carriers for returning the electronic device via one or more returning rewards upon identification of the compatibility. The device diagnosis subsystem 130 is configured to test for at least one fault factor associated with the electronic device, alignment of the electronic device with the one or more supportive carriers and an electronic and/or physical inspection of the electronic device. The device valuation subsystem 140 is configured to estimate a price for refurbishing the electronic device using a price estimation technique based on the at least one fault factor diagnosed for the electronic device. The device valuation subsystem 140 is also configured to determine a valuation of the repaired electronic device for reusage via a plurality of device reusage paths based on the price for refurbishing of the electronic device estimated.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus, and the like.

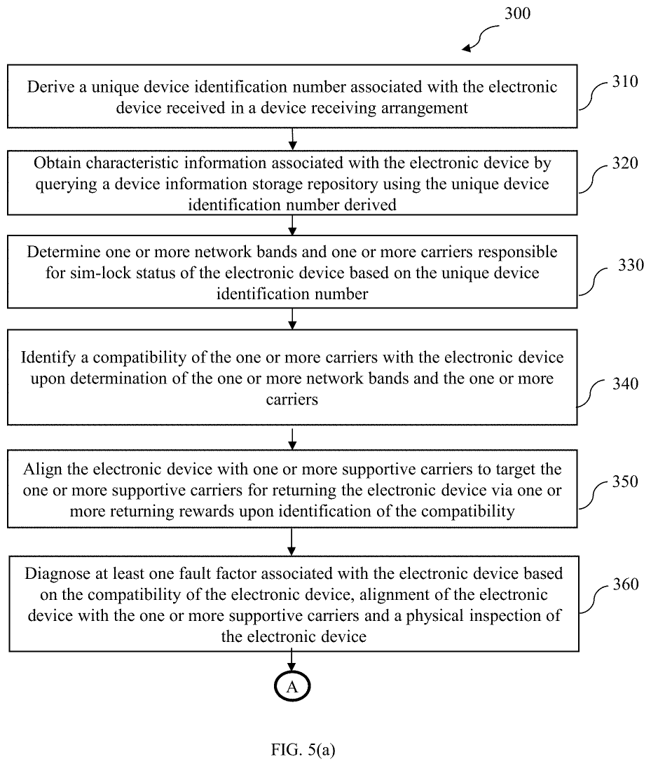

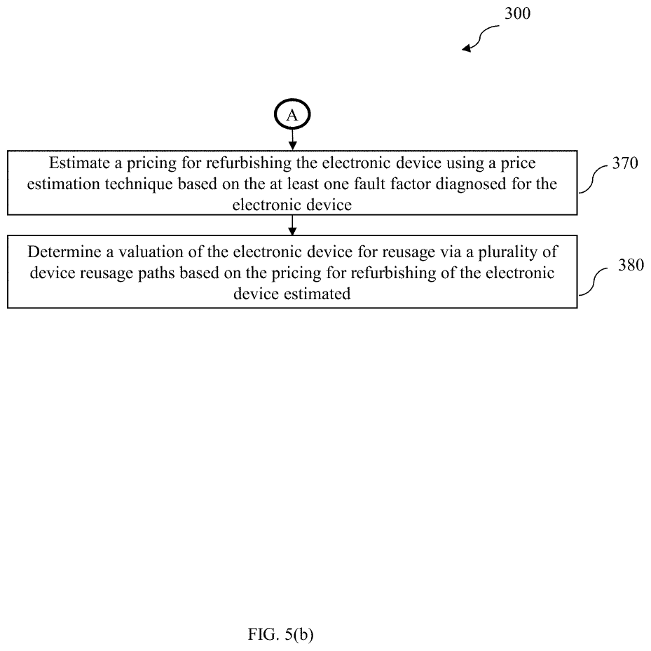

FIGS. 5(a) and 5(b) is a flow chart representing the steps involved in a method 300 for valuation of an electronic device in accordance with the embodiment of the present disclosure. The method 300 includes deriving, by a device information extraction subsystem, a unique device identification number associated with the electronic device received in a device receiving arrangement in step 310. In one embodiment, deriving the unique device identification number associated with the electronic device received in the device receiving arrangement may include deriving an international mobile equipment identity number (IMEI) number.

The method 300 also includes obtaining, by the device information extraction subsystem, characteristic information associated with the electronic device by querying a device information storage repository using the unique device identification number derived in step 320. In one embodiment, obtaining the characteristic information associated with the electronic device may include obtaining at least one of a manufacturing company of the electronic device, a manufacturing company location of the electronic device, a model number of the electronic device, a model name of the electronic device, a specification of the electronic device, a location of last active state of the electronic device, a last network connection associated with the electronic device or a combination thereof.

The method 300 also includes determining, by a device examination subsystem, one or more network bands and one or more carriers responsible for sim-lock status of the electronic device based on the unique device identification number in step 330. In one embodiment, determining the one or more network bands and the one or more carriers may include determining one or more mobile operators offering wireless connection services. The method 300 also includes identifying, by the device examination subsystem, a compatibility of the one or more carriers with the electronic device upon determination of the one or more network bands and the one or more carriers in step 340. Claimed is the innovative and unique ability to analyze the device's IMEI and understand the device's radio frequency and topology attributes on each and every device, which allows devices to be identified and aligned with networks with which they are compatible, and diverted from those they are not. This allows for more precise valuation throughout the reverse supply chain, from purchase via BYOD as well as optimizing for repairs and market pricing, globally.

The method 300 also includes aligning, by the device examination subsystem, the electronic device with one or more supportive carriers to target the one or more supportive carriers for returning the electronic device via one or more returning rewards upon identification of the compatibility in step 350. In one embodiment, aligning the electronic device with the one or more supportive carriers may include aligning the electronic device with one or more additional carriers allowing network connectivity of the electronic device without sim-locking of the electronic device. In some embodiment, the one or more returning rewards may include one or more bring your own device (BYOD) associated incentives. The BYOD incentives create value for one or more device owners, end consumers, the one or more carriers and others.

The method 300 also includes diagnosing, by a device diagnosis subsystem, at least one fault factor associated with the electronic device based on the compatibility of the electronic device, alignment of the electronic device with the one or more supportive carriers and a physical inspection of the electronic device in step 360. In one embodiment, diagnosing the at least one fault factor associated with the electronic device may include diagnosing at least one of a tampered electronic device, an inactivity status of the electronic device, an inactivity status of subscriber identity module (SIM) of the electronic device, a battery issue of the electronic device, a screen damage of the electronic device, functionality of all components including buttons, memory or processing chips, cameras, LIDAR, microphones, speakers, proximity sensors, gyroscopes, vibrator etc., one or more cosmetic issues of the electronic device, or a combination thereof.

The method 300 also includes estimating, by a device valuation subsystem, a pricing for refurbishing the electronic device using a price estimation technique based on the at least one fault factor diagnosed for the electronic device in step 370. In one embodiment, estimating the pricing for refurbishing the electronic device may include estimating a buying price applicable for a buyer, or a take to market price applicable for a seller of the electronic device. In such embodiment, the price estimation technique may include at least one of a linear regression technique, a gradient boosting technique, a random forest technique, market-based pricing, other techniques, or a combination thereof.

The method 300 also includes determining, by the device valuation subsystem, a valuation of the electronic device for reusage via a plurality of device reusage paths based on the pricing for refurbishing of the electronic device estimated in step 380. In one embodiment, determining the valuation of the electronic device for the reusage via the plurality of device reusage paths may include determining the valuation of the electronic device for the reusage via at least one of an insurance sale for the electronic device, a warranty presentation of the electronic device, a repair coverage of the electronic device, a carrier activation incentivizing scheme, market-based pricing for the device, or a combination thereof.

Various embodiments of the present disclosure relate to a system which brings transparency to the used mobile device market by reducing risk and adding value through comprehensive hardware and software grading analytics.

Moreover, the present disclosed system utilizes unique IMEI data associated with the electronic device for obtaining and enriching device diagnostic data and thus addresses every step of the device management process, from capture through refurbishment to final resale by using customized price estimation techniques. Hence, helps in obtaining a fair market value of the electronic device without involvement of any middleman in the process.

Furthermore, the present disclosed system offers cost of resolution estimation based on categorization of fault codes via diagnostic systems and thus enabling automation of actionable repair quotes and attachment of insurance sale or coverage for devices.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for valuation of an electronic device comprising:
a device information extraction subsystem hosted on a server, wherein the device information extraction subsystem is configured to:
derive a unique device identification number associated with the electronic device received in a device receiving arrangement; and
obtain characteristic information associated with the electronic device by querying a device information storage repository using the unique device identification number derived;
a device examination subsystem operatively coupled to the device information extraction subsystem, wherein the device examination subsystem is configured to:
determine one or more network bands and one or more carriers responsible for sim-lock status of the electronic device based on the unique device identification number;
identify a compatibility of the one or more carriers with the electronic device upon determination of the one or more network bands and the one or more carriers; and
align the electronic device with one or more supportive carriers to target the one or more supportive carriers for returning the electronic device via one or more carrier-based returning rewards programs upon identification of the compatibility;
a device diagnosis subsystem operatively coupled to the device examination subsystem, wherein the device diagnosis subsystem is configured to diagnose and test for at least one fault factor associated with the electronic device, alignment of the electronic device with the one or more supportive carriers and a physical and/or electronic inspection of the electronic device; and
a device valuation subsystem operatively coupled to the device diagnosis subsystem, wherein the device valuation subsystem is configured to:
estimate a price for refurbishing the electronic device using a price estimation technique based on the test for at least one fault factor diagnosed for the electronic device; and
determine a valuation of the electronic device for reusage via a plurality of device reusage paths based on the price for refurbishing of the electronic device estimated.

2. The system of claim 1, wherein the unique device identification number comprises an international mobile equipment identity (IMEI) number. wherein the system analyzes the device's IMEI and determines the device's radio frequency, topology attributes, and compatibility for each carrier network.

3. The system of claim 1, wherein the characteristic information comprises at least one of a manufacturing company of the device, a manufacturing company location of the device, a model number of the device, a model name of the device, a specification of the device, a location of last active state of the device, a last network connection associated with the device, or a combination thereof.

4. The system of claim 1, wherein the device information storage repository is created by pulling and integrating one or more details associated with the device from one or more external sources, wherein the device information storage repository stores the characteristic information of the device.

5. The system of claim 1, wherein the one or more supportive carriers comprises one or more additional carriers allowing network connectivity of the device without sim-locking of the device.

6. The system of claim 1, wherein the one or more returning rewards comprises one or more bring your own device associated incentives.

7. The system of claim 1, wherein the tests for at least one fault factor comprises at least one of a tampered electronic device, an inactivity or lack of device payment, an unfulfilled service contract, a status of a subscriber identity module (SIM) of the device, a battery issue, a screen damage, one or more cosmetic issues, functionality of all components including buttons, cameras, chipsets, or a combination thereof.

8. The system of claim 1, wherein the physical inspection of the device is performed by using one or more device inspection image acquisition devices, or one or more device inspection optical sensors deployed at the device receiving arrangement.

9. The system of claim 1, wherein the pricing for refurbishing the device comprises a buying price applicable for a buyer, a take to market price applicable for a seller of the device.

10. The system of claim 1, wherein the price estimation technique comprises at least one of a linear regression technique, a gradient boosting technique, a ransom forest technique, use of marketplace prices, or a combination thereof.

11. The system of claim 1, wherein the plurality of device reusage paths comprises at least one of marketplaces selling of the devices, a repair coverage of the device, a carrier activation incentivizing scheme, or a combination thereof.

12. The system of claim 1, further comprising a device status visualization subsystem operatively coupled to the device information extraction subsystem, the device examination subsystem, and the device diagnosis subsystem, wherein the device status visualization subsystem is configured to represent at least one of a unique device identification number, a compatibility status, and at least one fault factor of the device in one or more visualization forms.

13. The system of claim 12, wherein the one or more visualization forms comprises at least one of a bar graph, a pie chart, a scatter plot, a histogram, a tabular representation, a representation of a mobile device with working and faulty parts communicated through the use of contrasting colors to indicate functionality, or a combination thereof.

14. The system of claim 1, further comprising a device refurbishing tracking subsystem operatively coupled to the device valuation subsystem, wherein the device refurbishing tracking subsystem is configured to track a complete refurbishment process of the device in real-time.

15. The system of claim 1, further comprising a report generation subsystem configured to generate a plurality of reports to provide in depth information associated with proprietary analytics of the device in real time.

16. The system of claim 15, wherein the proprietary analytics comprises at least one of the unique device identification number, derived data of the device, a hardware status of the device, the at least one fault factor, a functionality of the device, or a combination thereof.

17. A method comprising:
deriving, by a device information extraction subsystem, a unique device identification number associated with an electronic device received in a device receiving arrangement;
obtaining, by the device information extraction subsystem, characteristic information associated with the device by querying a device information storage repository using the unique device identification number derived;
determining, by a device examination subsystem, one or more network bands and one or more carriers responsible for sim-lock status of the device based on the unique device identification number;
identifying, by the device examination subsystem, a compatibility of the one or more carriers with the device upon determination of the one or more network bands and the one or more carriers;
aligning, by the device examination subsystem, the device with one or more supportive carriers to target the one or more supportive carriers for returning the device via one or more returning rewards upon identification of a compatibility;
diagnosing, by a device diagnosis subsystem, at least one fault factor associated with the device based on the compatibility of the device, alignment of the device with the one or more supportive carriers, and a physical inspection of the device;
estimating, by a device valuation subsystem, a price for refurbishing the device using a price estimation technique based on the at least one fault factor diagnosed for the device; and
determining, by the device valuation subsystem, a valuation of the device for reusage via a plurality of device reusage paths based on the price for refurbishing of the device estimated.

18. The method of claim 17, further comprising representing, by a device status visualization subsystem operatively coupled to the device information extraction subsystem, the device examination subsystem, and the device diagnosis subsystem, at least one of the unique device identification number, a compatibility status, and the at least one fault factor of the device in one or more visualization forms.

19. The method of claim 17, further comprising tracking, by a device refurbishing tracking subsystem operatively coupled to the device valuation subsystem, a complete refurbishment process of the device in real-time.

20. The method of claim 17, further comprising analyzing, by the device examination subsystem, the device's international mobile equipment identity, radio frequency, topology attributes, and compatibility for each carrier network.
